(19) United States
(12) Patent Application Publication
(10) Pub. No.: US 2013/0163633 A1
(43) Pub. Date: Jun. 27, 2013

(54) THERMOCOUPLE WELDING TEST APPARATUS

(71) Applicants: DAN LIU, Wuhan City (CN); SHU-QI WU, Wuhan City (CN); LI-PING FAN, Wuhan City (CN); YU-LIN LIU, Wuhan City (CN)

(72) Inventors: DAN LIU, Wuhan City (CN); SHU-QI WU, Wuhan City (CN); LI-PING FAN, Wuhan City (CN); YU-LIN LIU, Wuhan City (CN)

(73) Assignees: HON HAI PRECISION INDUSTRY CO., LTD., Tu-Cheng (TW); HONG FU JIN PRECISION INDUSTRY (WUHAN) CO., LTD., Wuhan City (CN)

(21) Appl. No.: 13/569,270

(22) Filed: Aug. 8, 2012

(30) Foreign Application Priority Data
Dec. 26, 2011 (CN) 201110441194.5

(51) Int. Cl. G01K 15/00

(52) U.S. Cl. 374/1; 374/E15.001

(57) ABSTRACT

A thermocouple welding test apparatus for testing whether a thermocouple is normally welded includes a first comparison circuit, a second comparison circuit, a switch circuit and an indication circuit. The first comparison circuit receives a first DC voltage from the thermocouple, and compares the first DC voltage with a first reference voltage to output a first control signal. The second comparison circuit receives a second DC voltage from the thermocouple, and compares the second DC voltage with a second reference voltage to output a second control signal. The switch circuit receives the first control signal and the second control signal, and outputs an indication signal accordingly. The indication circuit receives the indication signal, and indicates whether the thermocouple is normally welded accordingly.

### BACKGROUND

1. Technical Field

The present disclosure relates to a thermocouple welding test apparatus for testing whether a thermocouple is normally welded.

2. Description of Related Art

A thermocouple is a junction between two different metals that produces a voltage related to a temperature difference. Thermocouples are a widely used as a type of temperature sensor for measuring temperature, and can also convert heat signal into electric signal, such as voltage signal. Thermocouples for practical measurement of temperature are junctions of specific alloys which have a predictable and repeatable relationship between temperature and voltage. Different alloys are welded together by a special apparatus to form thermocouples. The thermocouples need to be tested for whether the alloys are normally welded together before use, for ensuring the precision of the measurement.

Therefore there is a need for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an embodiment of a thermocouple welding test apparatus.

FIG. 2 is a circuit diagram of the thermocouple welding test apparatus of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

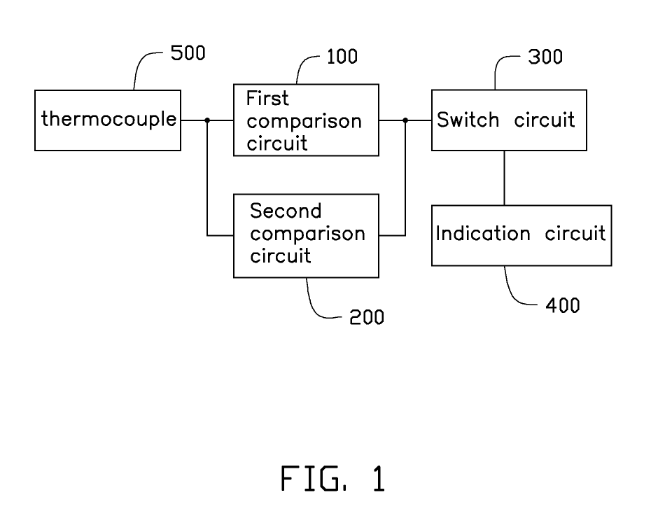

FIG. 1, illustrates a thermocouple welding test apparatus in accordance with an embodiment. The thermocouple welding test apparatus is adapted to test whether a thermocouple 500 is normally welded. The thermocouple welding test apparatus includes a first comparison circuit 100, a second comparison circuit 200, a switch circuit 300 and an indication circuit 400. The first comparison circuit 100 is electrically connected to the thermocouple 500 to receive a first DC voltage. The first comparison circuit 100 is adapted to compare the first DC voltage with a first reference voltage to output a first control signal. The second comparison circuit 200 is electrically connected to the thermocouple 500 to receive a second DC voltage. The second comparison circuit 200 is adapted to compare the second DC voltage with a second reference voltage to output a second control signal. The switch circuit 300 is adapted to receive the first control signal and the second control signal, and output an indication signal accordingly. The indication circuit 400 is adapted to receive the indication signal, and indicate whether the thermocouple 500 is normally welded accordingly.

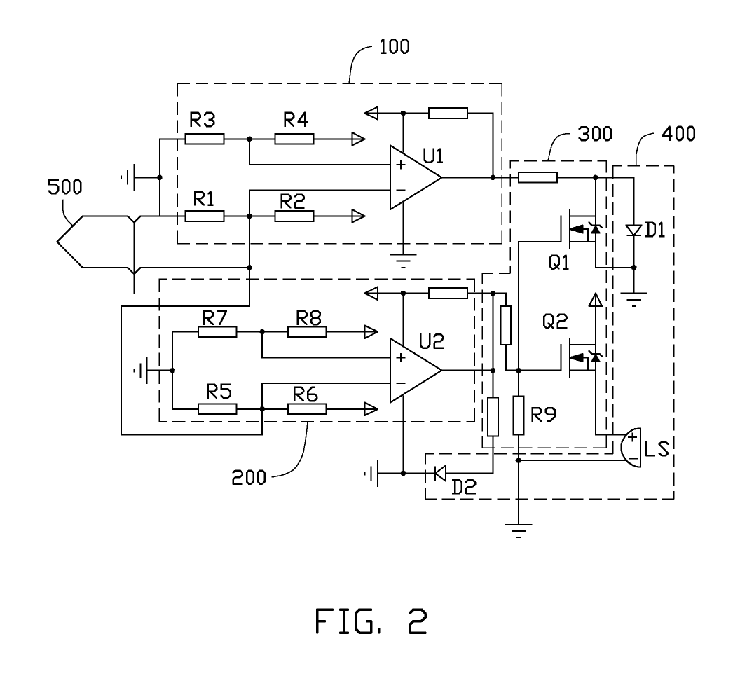

FIG. 2, illustrates the first comparison circuit 100 in accordance with one embodiment. The first comparison circuit 100 includes a first comparator U1, a first resistor R1, a second resistor R2, a third resistor R3 and a fourth resistor R4. An inverting input terminal of the first comparator U1 is electrically connected to a first terminal of the thermocouple 500 via the first resistor R1. The inverting input terminal of the first comparator U1 is adapted to receive a third DC voltage via the second resistor R2. A non-inverting input terminal of the first comparator U1 is electrically connected to the first terminal of the thermocouple 500 via the third resistor R3. The non-inverting input terminal of the first comparator U1 is adapted to receive the third DC voltage via the fourth resistor R4. A connection point between the first terminal of the thermocouple 500, the first resistor R1 and the third resistor R3 is grounded. A second terminal of the thermocouple 500 is electrically connected to a connection point between the first resistor R1 and the second resistor R2. An output terminal of the first comparator U1 is adapted to output the first control signal. In one embodiment, a resistance of the first resistor R1 is greater than a resistance of the third resistor R3. Resistances of the first resistor R1, the second resistor R2 and the fourth resistor R4 are 4.7 k/ohm. The resistance of the third resistor R3 is 3.9 k/ohm.

The second comparison circuit 200 includes a second comparator U2, a fifth resistor R5, a sixth resistor R6, a seventh resistor R7 and an eighth resistor R8. An inverting input terminal of the second comparator U2 is grounded via the fifth resistor R5. The inverting input terminal of the second comparator U2 is adapted to receive the third DC voltage via the sixth resistor R6. A non-inverting input terminal of the second comparator U2 is grounded via the seventh resistor R7. The non-inverting input terminal of the second comparator U2 is adapted to receive the third DC voltage via the eighth resistor R8. The second terminal of the thermocouple 500 is electrically connected to a connection point between the fifth resistor R5 and the sixth resistor R6. An output terminal of the second comparator U2 is adapted to output the second control signal. In one embodiment, a resistance of the fifth resistor R5 is greater than a resistance of the seventh resistor R7. Resistances of the fifth resistor R5, the sixth resistor R6 and the eighth resistor R8 are 4.7 k/ohm. The resistance of the seventh resistor R7 is 12 ohm.

The switch circuit 300 includes a first MOSFET Q1, a second MOSFET Q2 and a ninth resistor R9. Grids of the first MOSFET Q1 and the second MOSFET Q2 are electrically connected to the output terminal of the second comparator U2. A source of the first MOSFET Q1 is grounded. A drain of the first MOSFET Q1 is electrically connected to the output terminal of the first comparator U1. A grid of the second MOSFET Q2 is grounded via the ninth resistor R9. A drain of the second MOSFET Q2 is adapted to receive a fourth DC voltage. In one embodiment, the first MOSFET Q1 and the second MOSFET Q2 are N-channel MOSFETs. The fourth DC voltage is +6V.

The indication circuit 400 includes a first LED D1, a second LED D2 and a buzzer LS. An anode of the first LED D1 is electrically connected to the output terminal of the first comparator U1. A cathode of the first LED D1 is grounded. An anode of the second LED D2 is electrically connected to the output terminal of the second comparator U2. A cathode of the second LED D2 is grounded. An anode of the buzzer LS is electrically connected to the source of the second MOSFET Q2. A cathode of the buzzer LS is grounded.

In a working state, when the thermocouple 500 is not connected to the test apparatus, a voltage level at the inverting input terminal of the first comparator U1 is greater than a voltage level at the non-inverting input terminal of the first comparator U1. The output terminal of the first comparator U1 is adapted to output a low voltage level first control signal. A voltage level at the inverting input terminal of the second comparator U2 is greater than a voltage level at the non-inverting input terminal of the second comparator U2. The output terminal of the second comparator U2 is adapted to output a low voltage level second control signal. The first LED D1 and the second LED D2 both do not emit light.

A resistance of the thermocouple 500 is 30-100 ohm when a normally welded thermocouple 500 is connected to the test apparatus. A parallel resistance of the thermocouple 500 and the first resistor R1 is less than 100 ohm. The voltage level at the inverting input terminal of the first comparator U1 is less than the voltage level at the non-inverting input terminal of the first comparator U1. The output terminal of the first comparator U1 is adapted to output a high voltage level first control signal. The first LED D1 emits light. The voltage level at the inverting input terminal of the second comparator U2 is greater than the voltage level at the non-inverting input terminal of the second comparator U2. The output terminal of the second comparator U2 is adapted to output the low voltage level second control signal. The second LED D2 does not emit light.

When a short circuit welded thermocouple 500 is connected to the test apparatus, a resistance of the thermocouple 500 is less than 10 ohms. A parallel resistance of the thermocouple 500 and the fifth resistor R5 is less than 10 ohms. The voltage level at the inverting input terminal of the second comparator U2 is less than the voltage level at the non-inverting input terminal of the second comparator U2. The output terminal of the second comparator U2 is adapted to output a high voltage level second control signal. The second LED D2 emits light. The grid of the second MOSFET Q2 is adapted to receive the high voltage level second control signal. The second MOSFET Q2 turns on. The buzzer LS is adapted to receive the +6V fourth DC voltage to alarm. The grid of the first MOSFET Q1 is adapted to receive the high voltage level second control signal. The first MOSFET Q1 turns on. The voltage level of the first control signal at the output terminal of the first comparator U1 is pulled down to the low voltage level. The first LED D1 does not emit light. When an open circuit welded thermocouple 500 is connected to the test apparatus, a resistance of the thermocouple 500 is infinite. The working status of the first comparator U1 and the second comparator U2 is similar to when the thermocouple 500 is not connected to the test apparatus. The first LED D1 and the second LED D2 both do not emit light.

Even though numerous characteristics and advantages of the present disclosure have been set forth in the foregoing description, together with details of the structure and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A thermocouple welding test apparatus comprising:
a first comparison circuit electrically connected to a thermocouple to receive a first DC voltage; the first comparison circuit is adapted to compare the first DC voltage with a first reference voltage to output a first control signal;
a second comparison circuit electrically connected to the thermocouple to receive a second DC voltage; the second comparison circuit is adapted to compare the second DC voltage with a second reference voltage to output a second control signal;
a switch circuit adapted to receive the first control signal and the second control signal, and output an indication signal accordingly; and
an indication circuit adapted to receive the indication signal, and indicate whether the thermocouple is normally welded accordingly.

2. The thermocouple welding test apparatus of claim 1, wherein the first comparison circuit comprises a first comparator, a first resistor, a second resistor, a third resistor and a fourth resistor; an inverting input terminal of the first comparator is electrically connected to a first terminal of the thermocouple via the first resistor; the inverting input terminal of the first comparator is adapted to receive a third DC voltage via the second resistor; a non-inverting input terminal of the first comparator is electrically connected to the first terminal of the thermocouple via the third resistor; the non-inverting input terminal of the first comparator is adapted to receive the third DC voltage via the fourth resistor; a connection point between the first terminal of the thermocouple, the first resistor and the third resistor is grounded; a second terminal of the thermocouple is electrically connected to a connection point between the first resistor and the second resistor; and an output terminal of the first comparator is adapted to output the first control signal.

3. The thermocouple welding test apparatus of claim 2, wherein the second comparison circuit comprises a second comparator, a fifth resistor, a sixth resistor, a seventh resistor and an eighth resistor; an inverting input terminal of the second comparator is grounded via the fifth resistor; the inverting input terminal of the second comparator is adapted to receive a third DC voltage via the sixth resistor; a non-inverting input terminal of the second comparator is grounded via the seventh resistor; the non-inverting input terminal of the second comparator is adapted to receive the third DC voltage via the eighth resistor; the second terminal of the thermocouple is electrically connected to a connection point between the fifth resistor and the sixth resistor; and an output terminal of the second comparator is adapted to output the second control signal.

4. The thermocouple welding test apparatus of claim 3, wherein the switch circuit comprises a first MOSFET, a second MOSFET and a ninth resistor; grids of the first MOSFET and the second MOSFET are electrically connected to the output terminal of the second comparator; a source of the first MOSFET is grounded; a drain of the first MOSFET is electrically connected to the output terminal of the first comparator; a grid of the second MOSFET is grounded via the ninth resistor; and a drain of the second MOSFET is adapted to receive a fourth DC voltage.

5. The thermocouple welding test apparatus of claim 4, wherein the indication circuit comprises a first LED, a second LED and a buzzer; an anode of the first LED is electrically connected to the output terminal of the first comparator; an cathode of the first LED is grounded; an anode of the second LED is electrically connected to the output terminal of the second comparator; an cathode of the second LED is grounded; an anode of the buzzer is electrically connected to the source of the second MOSFET; and a cathode of the buzzer is grounded.

6. The thermocouple welding test apparatus of claim 3, wherein a resistance of the first resistor is greater than a resistance of the third resistor; and a resistance of the fifth resistor is greater than a resistance of the seventh resistor.

7. The thermocouple welding test apparatus of claim 3, wherein the resistance of the first resistor is equal to resistances of the second resistor and the fourth resistor; and the resistance of the fifth resistor is equal to resistances of the sixth resistor and the eighth resistor.

8. The thermocouple welding test apparatus of claim 4, wherein the first MOSFET and the second MOSFET are N-channel MOSFETs.

9. A thermocouple welding test apparatus for testing whether a thermocouple is normally welded, comprising:
a first comparison circuit adapted to receive a first DC voltage from the thermocouple, and compare the first DC voltage with a first reference voltage to output a first control signal;
a second comparison circuit adapted to receive a second DC voltage from the thermocouple, and compare the second DC voltage with a second reference voltage to output a second control signal;
a switch circuit adapted to receive the first control signal and the second control signal, and output an indication signal accordingly; and
an indication circuit adapted to receive the indication signal, and indicate whether the thermocouple is normally welded accordingly.

10. The thermocouple welding test apparatus of claim 9, wherein the first comparison circuit comprises a first comparator; an inverting input terminal of the first comparator is electrically connected to a first terminal of the thermocouple to receive the first DC voltage; a non-inverting input terminal of the first comparator is adapted to receive the first DC voltage; and an output terminal of the first comparator is adapted to output the first control signal.

11. The thermocouple welding test apparatus of claim 10, wherein the second comparison circuit comprises a second comparator; an inverting input terminal of the second comparator is electrically connected to a first terminal of the thermocouple to receive the second DC voltage; a non-inverting input terminal of the second comparator is adapted to receive the second reference voltage; and an output terminal of the second comparator is adapted to output the second control signal.

12. The thermocouple welding test apparatus of claim 11, wherein the switch circuit comprises a first MOSFET and a second MOSFET; grids of the first MOSFET and the second MOSFET are electrically connected to the output terminal of the second comparator; a source of the first MOSFET is grounded; a drain of the first MOSFET is electrically connected to the output terminal of the first comparator; and a drain of the second MOSFET is adapted to receive a fourth DC voltage.

13. The thermocouple welding test apparatus of claim 12, wherein the indication circuit comprises a first LED, a second LED and a buzzer; an anode of the first LED is electrically connected to the output terminal of the first comparator; an cathode of the first LED is grounded; an anode of the second LED is electrically connected to the output terminal of the second comparator; an cathode of the second LED is grounded; an anode of the buzzer is electrically connected to the source of the second MOSFET; and a cathode of the buzzer is grounded.
